(19) United States
(12) Patent Application Publication
(10) Pub. No.: US 2008/0149482 A1
(43) Pub. Date: Jun. 26, 2008

(54) REFERENCE ELECTRODE AND REFERENCE SOLUTIONS FOR USE THEREIN

(75) Inventors: Douglas Michael Marett, Toronto (CA); Nikolai Loukine, Toronto (CA); Thomas Mann, Knoxville, TN (US)

Correspondence Address: BLAKELY SOKOLOFF TAYLOR & ZAFMAN, 1279 OAKMEAD PARKWAY, SUNNYVALE, CA, 94085-4040, US

(73) Assignee: HealthWatchSystems, Inc., Alpharetta, GA (US)

(21) Appl. No.: 11/614,944

(22) Filed: Dec. 21, 2006

(51) Int. Cl. G01N 27/26; H01G 9/02

(52) U.S. Cl. 204/414; 252/62.2

(57) ABSTRACT

Reference electrodes for potentiometric measurement of pH and ion concentration typically use mercury calomel or silver/silver chloride element combined with a saturated solution of potassium chloride (KCl) for the development of a stable potential with respect to a sensing electrode when immersed in solution. The salt KCl is preferred because of it is almost equitransferent and thus minimizes the diffusion potential set up between the reference solution and the solution being tested. However, reference electrodes using concentrated solutions of KCl suffer a drawback, which is its propensity to develop a creeping salt discharge that rapidly covers surfaces with KCl crystals. This “salt creep” phenomenon appears to be unique to KCl; Salt creep is a major nuisance, particularly for reference electrodes used on semi-dry surfaces such as skin. It has been found that adding a secondary salt, such as sodium chloride on its own or with an evaporation inhibiting agent in selected ranges inhibits salt creep without adversely affecting the other properties of the reference solution.

### FIELD OF THE INVENTION

This invention relates to reference electrodes and reference solutions for use in reference electrodes. In particular, the present invention relates to reference electrodes and reference solutions for potentiometric measurement of a concentration of a substance in a solution in electrochemical contact with the reference solution.

### BACKGROUND OF THE INVENTION

A potentiometric measurement of the concentration of a substance in a solution is a measurement using the difference in potential generated between two electrodes. In potentiometric measurements, two electrodes, often referred to as a sensing electrode and a reference electrode, are immersed in a solution of an ionic salt. A potential difference will then be established between the electrodes which is a function of the concentration of a substance, generally a dissolved ionic species or other ionic substance in the immersed solution.

A pair of conventional half cells, 8A, 8B, for use in potentiometric measurement, are shown in FIG. 1a. The first half cell 8A, comprises a reference electrode 12R, having a reference solution 2, a reference electrode element 1R and a salt bridge 4. The reference electrode element 1R may be a solid distinctive element consisting of a mixture of silver metal and silver chloride, and the reference solution 2 has a known concentration of an electrolyte, such as potassium chloride. Preferably, the known concentration is relatively large, such as 1M KCl to 4M KCl, but other concentrations are possible. The second half cell 8B comprises a sensing electrode 12S in electrochemical contact with a potassium chloride test solution 3, which in this example is 0.4M KCl. The sensing electrode 12S comprises test electrode member 1S, also consisting of a mixture of silver metal and silver chloride. The salt bridge 4 is also 4M KCl and places the reference solution 2 in electrochemical contact with the test solution 3.

As shown in FIG. 1a, both electrode elements 1R and 1S are identical and both half cell solutions 2, 3 have the same substances but different concentrations. In this case, the pair of half cells 8A and 8B may be referred to as a concentration cell 10.

Each silver/silver chloride electrode element 1R, 1S in the concentration cell 10 develops a potential, which is a function of the activity of the Cl-ion in the corresponding solution 2, 3 in which they are immersed. This potential can be measured with the voltmeter 5, and is related to or is a function of the concentration of the Cl-ion. This is because each electrode 12R, 12S is an electrochemical two-phase system where ions or electrons can cross a phase boundary. At the boundary between the electrode element 1R, 1S and the solution 2, 3 there will be an electrochemical potential as a result of the ion activity, which differs from the chemical potential by the additional electrical work necessary when the ions leave their phase.

Thus the silver/silver chloride electrodes elements 1R, 1S develop half cell potentials which depend on the concentration of the Cl-ion in the solution 2, 3 with which they are in electrochemical contact. According to the Nernst Equation, at 25° C. the potential developed by a Ag/AgCl half cell increases by about a theoretical amount of 59 mV for every 10× difference in the concentration of Cl—, while in practice this may vary. Thus in the example of FIG. 1a, the potential difference between the two cells 8A, 8B would be about ˜59 mV because the known reference solution 2 has a concentration of 4M KCl, while the test solution 3 has a concentration of 0.4M KCl.

In this embodiment, the reference electrode 12R, which comprises the reference electrode element 1R, the reference solution 2 and the salt bridge 4, has a stable potential created by the Cl-ion activity of the 4M KCl concentration solution. This stable potential is generally about +197 mV at 25 degrees Celsius with respect to a Hydrogen Reference electrode.

When the salt bridge 4 of this reference electrode 12R is immersed in the test solution 3 along with a bare Ag/AgCl electrode element 1S, then the potential difference between the test electrode element 1S and the reference electrode element 1R will be a function of the activity of the Cl-ion acting on the test electrode element 1S, which is related to the concentration of the Cl-ion in the test solution 3. The reference electrodes 12R provides a stable known potential by which to measure this potential difference. It is understood that the reference electrode 12R can be used as a stable reference electrode in any type of concentration cell 10 or ion selective electrode for measuring various types of ionic substances.

Other types of electrodes have also been known to be used as reference electrodes. These other types of reference electrodes include mercury calomel electrodes. For example FIG. 1b illustrates a conventional mercury calomel reference electrode, shown generally by reference numeral 26. As illustrated in FIG. 1b, the mercury calomel reference electrode 26 comprises a body 28 having a lead in wire 21, a structural element or insulator 22, and a mercury/mercury I chloride mixture 23 inside a structural tube or porous envelope 24. The mixture 23 is in electrochemical contact with a saturated KCl solution 25 in the body 28. A porous liquid junction 27 allows the saturated KCl to make contact with the test solution when this reference electrode 26 is immersed in it, or, is otherwise in electrochemical contact with it, such as through the porous liquid junction 27.

Accordingly, the mercury calomel reference electrode 26 shown in FIG. 1b is another type of common reference electrode for potentiometric measurement of ionic species, such as ions and pH. In this case, the reference electrode element comprises the mercury/mercury I chloride (Hg₂ Cl₂) mixture usually in the glass tube or porous envelope, which is in electrochemical contact with the lead wire 21, which is generally platinum. The Hg/Hg₂ Cl₂ element 23 in FIG. 1b is in direct contact with the saturated KCl reference solution 25 contained in the body 28. Similar to the silver/silver chloride reference electrode 12R discussed above, the mercury calomel reference electrode 26 forms a sustainable potential with respect to the saturated KCl solution 25 in which it is immersed, thus acting as a stable half cell by which to reference the variable potential measured by an ion sensing element (not shown in FIG. 1b). Like the silver/silver chloride reference electrode 12R discussed above and illustrated in FIG. 1a, the mercury calomel reference electrode 26 contains a chamber of saturated KCl that makes contact with the test solution (not shown in FIG. 1b) via a porous liquid junction 27, thus completing the electrical circuit when used with a sensing electrode (not shown in FIG. 1b).

However, mercury calomel reference electrodes, such as the reference electrode 26 illustrated in FIG. 1b, are not generally used for measurements to be taken in a living body or body of fluid, because the mercury calomel element 23 is hazardous since it relies on mercury. Therefore, in cases where measurements are to be taken in a living body or body fluid, the silver/silver chloride electrode is generally employed.

However, reference electrodes 12R, 26 containing high concentrations of potassium chloride KCl can suffer from “salt creep”, which is generally a creeping salt discharge from their porous liquid junction 27 if exposed to the air for any length of time. This could be a nuisance to the user since the electrode must he cleaned of the creeping salt discharge prior to re-use. The difficulty with salt creep arises in any type of electrode using a solution having KCl. In other words, both the reference electrode 12R and the calomel reference electrode 26 would both suffer from salt creep because of the presence of the KCl in the reference solution, and this is not dependent on the structure of the electrode element 1R, 23. Furthermore, the difficulty with salt creep becomes more acute when a porous membrane, such as the porous liquid junction 27 is present. Furthermore, the problem is compounded in cases where the liquid junction 27 is not consistently exposed to the test solution 11, or is otherwise allowed to dry, which aggravates the salt creep. Accordingly, one object of this invention is to provide an improved solution or composition for use in a reference electrode 12R, and 26 having a KCl reference solution, which reduces salt creep from the liquid junction, while maintaining the chloride ion activity necessary for proper performance.

While reference solutions comprising substances other than KCl have been proposed in the past, these reference solutions suffer from other disadvantages such that reference solutions having KCl are preferred, even if salt creep is present. One reason for this is the “diffusion potential” which is present at the transition zone between the reference solution and the test solution. It is believed that this diffusion potential is due in part by the differing electrochemical potentials and the differing mobility's of the cations and anions involved. This diffusion potential ultimately becomes a leading cause of uncertainty in the practical measurement of pH or other ion concentrations of other ionic species. In order to keep this diffusion potential small, it is best to use a reference solution composed of an electrolyte that has anion and cation migration velocities that are nearly equal, generally referred to as equitransferent. This condition is fulfilled to a very good approximation by potassium and chloride ions. For example, the ionic mobility of potassium differs from that of chloride by only about 3.8%, however, the ionic mobility of sodium differs from chloride by about 52%. For this reason, a reference solution composed of 4M NaCl for example, will have a much greater diffusion potential, and thus increased measurement uncertainty, than a reference electrode having a reference solution of 4M KCl. At least for this reason, reference solutions of potassium chloride are preferred over other chloride solutions, even though potassium chloride suffers from salt creep.

Accordingly, one of the disadvantages of the prior art is that reference electrodes having the beneficial aspects of KCl reference solutions exhibit salt creep at the liquid junction, which potentially decreases the chloride ion activity and increases maintenance of the reference electrode. A further disadvantage of the prior art is that the reference solutions having the beneficial aspects of KCl suffer from salt creep if the porous membrane in electrochemical contact with the reference solution is exposed to the air, or a dry or semi dry surface for any appreciable period of time.

### SUMMARY OF THE INVENTION

Accordingly, it is an object of this invention to at least partially overcome some of the disadvantages of the prior art. Also, it is an object of this invention to provide an improved type of reference electrode addressing some of the disadvantages of the prior art reference electrodes.

In particular, in one embodiment, the present invention provides a reference electrode solution that retains the beneficial effects of potassium chloride, but has additives within defined ranges which assist in reducing salt creep.

Accordingly, in one of its aspects, the present invention resides in a electrolyte reference solution for use in a reference electrode, said solution being in electrochemical contact with an electrode member of the reference electrode, said solution comprising: (a) a 1M to saturated aqueous KCl solution; (b) 0.6% to 2.46% (by weight of solution) of a secondary water-soluble inorganic chloride salt other than KCl; and (c) 4.6% to 15.93% (by weight of solution) of an evaporation inhibiting agent.

In a further aspect the present invention provides a half-cell reference electrode comprising: an electrode member comprising silver/silver chloride; a gelled or viscous reference solution in electrochemical contact with the electrode member, said reference solution comprising a 1M to saturated potassium chloride solution (KCl) and 4.6% to 15.93% (by weight of solution) of an evaporation inhibiting agent; a porous liquid junction portion for facilitating electrochemical contact between the reference solution and a test solution.

In a still further aspect, the present invention provides a half-cell reference electrode comprising: an electrode member comprising silver/silver chloride; a gelled or viscous reference solution in electrochemical contact with the electrode member, said reference solution comprising a 1M to saturated potassium chloride solution (KCl) and 0.5% to 2.46% (by weight of solution) of a secondary water soluble inorganic chloride salt other than KCl; and a porous liquid junction portion for facilitating electrochemical contact between the reference solution and a test solution.

It has been appreciated that adding a secondary salt other then KCl, such as NaCl, together with an evaporation inhibiting agent, such as glycerol, combined to improve the characteristics of the reference electrode comprising a reference solution having these additives. In particular, addition of the secondary salt in the range of 0.6% to 2.46% (by weight of solution) together with an evaporation inhibiting agent in the range of 4.6% up to about 16% would exhibit favourable characteristics over a control solution not having these additives. The favourable characteristics included decreases in salt creep as well as preferred spontaneous wetting of porous liquid junctions for electrochemical contact with the reference solution, without adversely affecting the Nernstian response. More preferred ranges for the addition of both a secondary salt and an evaporation inhibiting agent were found to be 0.6% to 2.25% (by weight of solution) of a secondary salt other then KCl and 4.6% to 12% (by weight of solution) of an evaporation inhibiting agent such as glycerol. The most preferred combination was found to occur at about 1.14% by weight of solution of the secondary salt and at about 8.75% of the evaporation inhibiting agent and it is believed that a variation of these amounts up or down by about 10% such as 0.1% of the secondary salt and 0.9% of the evaporation inhibiting agent would not greatly effect the characteristics of the reference solution.

In addition to adding the two additives, namely as the secondary salt and the evaporation inhibiting agent, it was also appreciated that adding either a secondary salt or the evaporation inhibiting agent in specific ranges would also improve characteristics of the reference electrode or the secondary salt, and in particular sodium chloride. It was found that the addition of sodium chloride in the range of 0.5% to 2.46%, and as high as 3.7% (by weight of solution) based on an extrapolation of the data, would produce an appreciable decrease in the salt creep of KCl, without adversely affecting the Nernstian response of the reference electrode. More preferred ranges for the addition of the secondary salt found to be in the range of 0.5% to 2.46% (by weight of solution) and still more preferred 0.75% to 2.25% (by weight of solution).

With the addition an evaporation inhibiting agent, preferred characteristics in the reference electrode were found to occur at concentrations in the range of 4.6% to no more then 16% (by weight of solution) of the evaporation inhibiting agent and more preferably 4.6% to about 12%. Concentrations of these evaporation inhibiting agents above 18% were found to cause other difficulties with the reference electrode, such that the upper range for the evaporation inhibiting agent would appear to be about 18% (by weight of solution).

In addition, a gelling agent, such as agar, was added to form a viscous or gelled reference solution. The gelling agent created a matrix within which the reference solution could be contained. Use of the gelling agent would be more preferred in cases where the porous liquid junctions have larger pore sizes.

Further aspects of the invention will become apparent upon reading the following detailed description and drawings, which illustrate the invention and preferred embodiments of the invention.

### BRIEF DESCRIPTION OF THE DRAWINGS

In the drawings, which illustrate embodiments of the invention;

FIG. 1a is an example of a conventional concentration cell having a silver/silver chloride element;

FIG. 1b is an example of a conventional saturated calomel reference electrode;

FIG. 2 is an embodiment of a sensing electrode/reference electrode pair, using a reference solution according to some embodiments of the present invention; and

FIG. 3 is a graph of the rate of salt creep of potassium chloride from reference electrodes of a design similar to that of FIG. 2, using various recipes described herein.

### DETAILED DESCRIPTION OF THE PREFERRED EMBODIMENTS

Preferred embodiments of the invention and its advantages can be understood by referring to the present drawings and this description. In the present drawings, like numerals are used for like and corresponding parts of the accompanying drawings.

This invention pertains to a reference electrode having a novel reference solution that retains most of the beneficial effects of potassium chloride, but has additional ingredients in defined ranges which reduce salt creep Reference electrodes using concentrated solutions of KCl suffer from a propensity to develop a creeping salt discharge which slowly covers surfaces with KCl crystals often referred to as “salt creep”. This “salt creep” phenomenon appears to be unique to KCl but similar creeping phenomenon have also been exhibited by liquid helium and specific lubricating oils but these are non-salt creeps which vary by other dynamics.

It is generally believed that salt creep of KCl is a reaction of the crystallization of KCl as the concentrated solution slowly dries. Salt creep is a nuisance, particularly for reference electrodes used on semi-dry surfaces such as skin, and/or reference electrodes that are not in contact with a test solution for appreciable periods of time.

In one embodiment, a second salt other than KCl is added in a defined concentration range to the concentrated KCl reference solution to assist in reducing the crystallization of the KCl. This second salt could be another water-soluble inorganic salt with a chloride ion, more preferably this second salt solution is sodium chloride (NaCl). The strategy of using another chloride ion salt is that the crystallization is reduced, while the chloride ion activity of the solution remains relatively unchanged. Other examples of chloride ion salts that can be added to concentrated KCl reference solutions include MgCl₂ and CaCl₂. The addition of NaCl as well as MgCl₂ and CaCl₂ are preferred for living body application such as for use with skin measurements, or other living body or body of fluid applications for non-living body applications, LiCl, CuCl₂ or BaCl₂ would also be suitable. Ammonium chloride (NH₄Cl) is less suitable, due to its ability to dissolve the silver chloride electro-coating of the reference electrode element.

In a further embodiment, an evaporation inhibitor can be added to the reference solution, such as a polyhydric alcohol, including polyol, in addition to the second salt. These evaporation inhibitors include glycols (or diols) such as polyethylene glycol, trials such as glycerol and higher polyols such as monosaccharides, disaccharides and sorbitol.

In certain preferred embodiments, gelling agents such as Agar may also be added to the KCl reference solution. These gelling agents slow the rate of liquid flow through the porous liquid junction into the test solution by forming a matrix that retains the electrolyte solution. This causes the reference solution to be viscous or a gel.

It is further preferred to having gelling agents, such as Agar, combined with an evaporation inhibiting agent, such as glycerol, in the concentrated KCl reference solution. Without limiting the scope of the invention it is believed, that in this embodiment the Glycerol inhibits syneresis of agar gels. Syneresis is a spontaneous separation of hydrogels into two phases where one phase is enriched with water and low molecular weight components and the other is enriched with high molecular weight components. The first phase is very mobile. It is this mobile phase with the low molecular weight salts that tends to creep through the porous liquid junction. Of course, the compounds that retard syneresis also inhibit evaporation because their boiling points are higher than the boiling point of water. It is believed, without limiting the scope of the invention, that the addition of a second chloride salt (other that KCl) inhibits crystallization of the KCl solution and therefore decreases salt creep. Glycerol that contains three hydroxy-groups may stabilize the agar gel (and prevent its syneresis) by hydrogen bonding between its hydroxy-groups and hydroxy-groups of agar. Polyvinyl alcohol may also be used as an evaporation-inhibiting agent. Furthermore, polyvinyl alcohol has also been found in some cases to act as both a gelling agent and also as an evaporation/syneresis inhibiting agent.

In still a further embodiment, together with the addition of an evaporation inhibitor, such as glycerol, it has been preferred to add a gelling agent selected from the group consisting of water-soluble polysaccharides such as starch, agar, amylose, dextrans, carboxymethyl cellulose, sodium salt, proteins such as gelatin, water-soluble acrylates and methacrylates such as polyacrylamide, polyhydroxyethylaerylate, polyhydroxyethylmethacrylate, polyacrylic acid and, polymethacrylic acid and their sodium and potassium salts, polyvinyl alcohol and mixtures of thereof.

Preferred embodiments of the invention combine one or more of these additives for an improved reference electrolyte solution of concentrated KCl with a low propensity for salt creep. Thus the preferred KCl electrolyte would have in combination a secondary chloride salt and an evaporation inhibiting agent. Although the salt creep is substantially inhibited by these additives, the addition of the gelling agent adds additional advantages in reducing liquid loss which is of particular importance when using liquid junctions, and in particular liquid junctions with larger pore sizes.

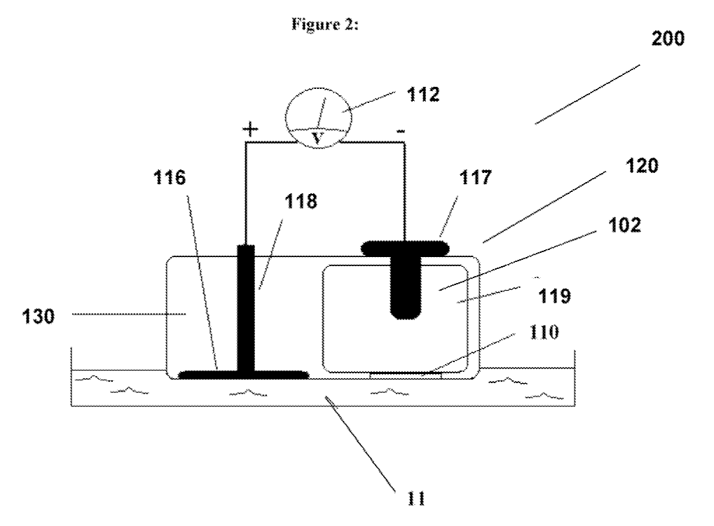

FIG. 2 shows an example of a device for sensing Cl. The device comprises a reference electrode 120 used in conjunction with a sensing electrode 130, for the determination of the unknown Cl— concentration of a test solution 11. In this embodiment, the test electrode 130 comprises a test electrode element 116, which is preferably a silver/silver chloride electrode and an electrical lead 118. The reference electrode element 117, is also preferably a silver/silver chloride electrode, which is inserted into a chamber 119 containing a reference solution 102 comprising a 4M KCl solution and one or more of these additives discussed above. The reference electrode 120 also preferably comprises a porous frit liquid junction 110 having small pores to keep the rate of reference solution transfer to the test solution 11 down to a minimum (i.e. a few uL solution 102 per hour) to avoid contaminating the test solution 11 with the reference solution 102. The potential difference is conveniently measured by placing a potential sensing circuit 112 such as a voltmeter or other equivalent device or circuit (not shown) across the lead 118 and reference element 117.

Accordingly, the device 200 is an example of one type of combination electrode comprising a reference electrode 120 used for a potentiometric measurement of a concentration of a substance in this case Cl— in a test solution 11. The liquid-junction portion, such as the porous frit liquid-junction 110, illustrated in FIG. 2, is used to create an electrochemical connection with the test solution 11, while at the same time maintaining a lower amount of outflow. Use of the reference solution 102 according to the present invention has been found to decrease the amount of salt creep and salt leakage at the liquid junction portion, as exemplified by the following experiments.

### Experiment 1

### Methodology

In this experiment 5 sensors similar to device 200 shown in FIG. 2 comprised of combining Cl— sensing electrode 130 and a reference electrode 120 using a concentrated KCl reference solution corresponding to each of the following recipes were tested over a period of 4 weeks to determine their rate of salt creep, and the Nernstian response to calibration solutions. The reference part of each of these combination Cl— sensors had 2 frits and the average salt creep of the 2 frits for each reference electrode were determined. Since all the sensing elements were the same, it is understood that any differences in Nernstian response were attributed to differences in the reference electrodes with different electrolytes.

### Recipes;

The control sensor recipe for the reference electrolyte solution was:
Recipe 1 (Control):
10 mL of 4M potassium chloride (KCl) solution, saturated with silver chloride (AgCl)
200 mg of Difco Agar, technical grade.
To this control recipe 1, were added: NaCl and/or glycerol as outlined below and expressed as % by weight of total solution:

| | |
|---|---|
| Recipe 2: 0.34% NaCl | |
| 40.5 mg NaCl | (Note: Corresponds to 1.35% NaCl by weight added to total KCl) |
| Recipe 3: 0.50% NaCl | |
| 60 mg NaCl | (Note: Corresponds to 2% NaCl by weight added to total KCl) |
| Recipe 4: 1.24% NaCl | |
| 150 mg NaCl | (Note: Corresponds to 5% NaCl by weight added to total KCl) |
| Recipe 5: 4.63% Glycerol | |
| 0.578 g Glycerol | (Note: Corresponds to 5% by weight added to 4M solution, excluding agar) |
| Recipe 6: 8.85% Glycerol | |
| 1.156 g Glycerol | (Note: Corresponds to 10% by weight added to 4M solution, excluding agar) |

Accordingly, a total of 30 reference electrodes (five reference electrodes having each of the six above noted recipes) were tested. The addition of agar as a gelling agent to all of the Recipes 1-6 gelled the reference solutions. These reference electrodes were then left open on a bench for a period of 4 weeks. Two parameters were periodically monitored, namely:

(1) Their rate of salt creep, as ranked by salt fouling, and

(2) The Nernstian response of the built-in Cl— sensing electrode to the reference electrode using a given recipe.

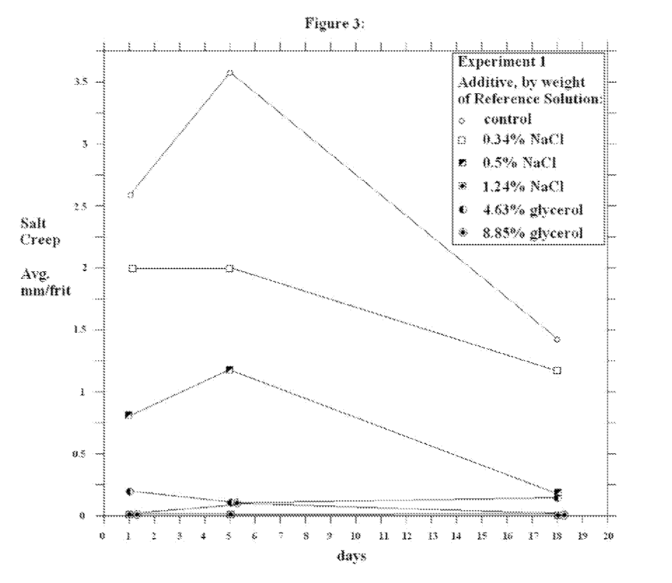

Table 1 below summarizes the results of this experiment 1 using recipes 1-5 identified above. These results from Table 1 are also illustrated in FIG. 3. The number of frit junctions with visible salt creep was noted on each testing day, and, the extent of the creep was measured in mm per frit. Also, the Nernstian response of the sensors to Cl-ion were tested using calibrated solutions. The average salt creep in mm/frit was then calculated. The salt was cleaned off after days 1, 5 and 18 so that the rate of fresh salt creep could be determined.

TABLE 1

| | Salt Creep: | Salt Creep: | Salt Creep: | | | |
|---|---|---|---|---|---|---|
| | 1 day | 5 days | 18 days | Nernstian | Nernstian | |
| | average | average | average | Response | Response | |
| Recipe | mm/frit | mm/frit | mm/frit | 5 days | 18 days | Ranking: |
| (1) Control | 2.6 | 3.6 | 1.4 | 46.2 mV | 45.7 mV | 5 |
| (2) 0.34% NaCl | 2.0 | 2.0 | 1.2 | 45.1 mV | 43.6 mV | 4 |
| (3) 0.50% NaCl | 0.8 | 1.2 | 0.2 | 42.6 mV | 43.9 mV | 3 |
| (4) 1.24% NaCl | 0 | 0 | 0 | 48.3 mV | 43.4 mV | 1 |
| (5) 4.63% Glycerol | 0.2 | 0.1 | 0.2 | 45.9 mV | 44.0 mV | 2 |
| (6) 8.85% Glycerol | 0 | 0.1 | 0 | 43.9 mV | 44.7 mV | 1 |

All of the sensors displayed Nernstian responses in the 40-50 mV/decade range of Cl concentration difference, and so were roughly equivalent by this parameter. For salt creep, the control had the highest salt creep, and Recipe 2 (0.34% NaCl % weight of total solution corresponding to 1.35% NaCl by weight added to total KCl) did not greatly improve the salt creep. At Recipe 3 (0.5% NaCl by weight of solution corresponding to 2% NaCl added to weight of KCl), the salt creep is decreased as compared to the Recipe 1 (the control), and at Recipe 4 (1.24% NaCl by weight solution corresponding to 5% added to weight of KCl) the salt creep has substantially decreased. This suggests that a percentage of NaCl between 0.5% to 1.24% by weight of total solution (2-5% by weight added to weight of KCl) will produce a noticeable decrease of salt creep.

Furthermore, recipes 5 and 6 showed that the addition of glycerol would produce a noticeable decrease in salt creep of about 90% less than the control (Recipe 1) even at the lowest level tested, namely Recipe 5 (4.63% glycerol to weight of total solution corresponding to 5% glycerol by weight of the solution added to 4M Solution of KCl, excluding agar). The salt creep further decreased when the amount of glycerol was increased to 8.85% by weight of total solution (corresponding to 10% by weight added to 4M Solution of KCl, excluding agar) at Recipe 6.

Further experiments, as outlined below were performed.

### Experiment 2

### Methodology

In this experiment 15 Cl— combination sensors similar to device 200 shown in FIG. 2, each comprised of a sensing electrode 130 and a reference electrode 120, were tested for each recipe (except for recipe 9 where only 5 devices 200 were tested). These were tested over a period of 4 weeks to determine their rate of salt leakage, frit liquid junction wetness following unsealing, and the Nernstian response to calibration solutions. Since all the sensing electrodes 130 were the same for each reference electrode 120, any differences in Nernstian response were attributed to differences in the reference electrodes with different electrolytes.

### Recipes:

The recipe used for the reference electrolyte solution in the control reference electrodes 120 was:
Recipe 1:
10 mL of 4M potassium chloride (KCl) solution, saturated with silver chloride (AgCl)
200 mg of Difco Agar, technical grade.
To this control recipe 1, were added NaCl and/or glycerol as outlined below and expressed as by weight of total solution:

| | |
|---|---|
| Recipe 2: 8.85% glycerol | |
| 1.156 g glycerol | (Note: Corresponds to 10% by weight added to 4M solution, excluding agar) |
| Recipe 3: 2.46% Sodium Chloride (NaCl) | |
| 300 mg NaCl | (Note: Corresponds to 10% NaCl by weight added to total KCl) |
| Recipe 4: 4.60% Glycerol + 0.60% NaCl | |
| 0.578 g glycerol | (Note: Corresponds to 5% by weight added to 4M solution, excluding agar) |
| 75 mg NaCl | (Note: Corresponds to 2.5% NaCl by weight added to total KCl) |
| Recipe 5: 8.75% Glycerol + 1.14% NaCl | |
| 1.156 g glycerol | (Note: Corresponds to 10% by weight added to 4M solution, excluding agar) |
| 150 mg NaCl | (Note: Corresponds to 5% NaCl by weight added to total KCl) |
| Recipe 6: 16.10% Glycerol + 1.04% NaCl | |
| 2.312 g glycerol | (Note: Corresponds to 20% by weight added to 4M solution, excluding agar) |
| 150 mg NaCl | (Note: Corresponds to 5% NaCl by weight added to total KCl) |
| Recipe 7: 8.66% Glycerol + 2.25% NaCl | |
| 1.156 g glycerol | (Note: Corresponds to 10% by weight added to 4M solution, excluding agar) |
| 300 mg NaCl | (Note: Corresponds to 10% NaCl by weight added to total KCl) |
| Recipe 8: 15.93% Glycerol + 2.07% NaCl | |
| 2.312 g glycerol | (Note: Corresponds to 20% by weight added to 4M solution, excluding agar) |
| 300 mg NaCl | (Note: Corresponds to 10% NaCl by weight added to total KCl) |
| Recipe 9: 22.57% Glycerol | |
| 3.468 g glycerol | (Note: Corresponds to 30% by weight added to 4M solution, excluding agar) |

These sensors were left open on a bench for a period of 4 weeks. Three parameters were monitored, namely:

(A) The Nernstian response of the built-in Cl— sensing electrode to the reference electrode using a given recipe;

(B) Their rate of salt/moisture leakage, as measured by weight loss; and

(C) The number of frits that were wetted and active immediately after unsealing.

Table 2 below summarizes the results of the testing. The Nernstian response (mV change per decade Cl— change) was measured once a week for 4 weeks (Parameter A). The Nernstian response was ranked by its standard deviation for each group. The average weight loss in grams at the end of 4 weeks was noted (Parameter B). The percentage number of porous frit liquid junctions that were wetted spontaneously by the gel was also noted (Frits Active, Parameter C). The six best recipes were ranked for the three parameters (A, B, C) listed above with 5 being the best rank and 6 being the lowest rank because recipes 6, 8 and 9 were excluded from the ranking due to accelerated weight loss due from the addition of higher levels of glycerol.

The recipe with the lowest score was taken as the overall best.

TABLE 2

| | Nernstian Response (Avg.) (A) | | | | | Weight | Frits | | | | |
|---|---|---|---|---|---|---|---|---|---|---|---|
| Recipe: | | | | | Avg. 4 | Loss: | Active | Ranking | | | Avg. |
| N = 15 | Week 1 | Week 2 | Week 3 | Week 4 | weeks | (B) | (C) | (A) | (B) | (C) | Rank |
| (1) Control | 52 | 48 | 48 | 50 | 50 | 0.287 | 87% | 6 | 6 | 3 | 5.0 |
| Standard Dev. | | | | | 3.73 | 0.091 | | | | | |
| (2) 8.5% | 54 | 51 | 52 | 52 | 52 | 0.066 | 90% | 4 | 2 | 2 | 2.7 |
| Glycerol | | | | | | | | | | | |
| Standard Dev. | | | | | 1.48 | 0.016 | | | | | |
| (3) 2.46% NaCl | 53 | 50 | 51 | 52 | 52 | 0.060 | 73% | 3 | 1 | 4 | 2.7 |
| Standard Dev. | | | | | 1.40 | 0.009 | | | | | |
| (4) 4.60% | 55 | 53 | 50 | 53 | 53 | 0.097 | 90% | 5 | 5 | 2 | 4.0 |
| Glycerol + 0.60% | | | | | | | | | | | |
| NaCl | | | | | | | | | | | |
| Standard Dev. | | | | | 2.00 | 0.056 | | | | | |
| (5) 8.75% | 54 | 50 | 52 | 52 | 52 | 0.089 | 97% | 2 | 4 | 1 | 2.3 |
| Glycerol + 1.14% | | | | | | | | | | | |
| NaCl | | | | | | | | | | | |
| Standard Dev. | | | | | 1.38 | 0.018 | | | | | |
| (6) 16.10% | 54 | 51 | 51 | ND | ND | >0.072 | 93% | | | | Excluded |
| Glycerol + 1.04% | | | | | | | | | | | |
| NaCl | | | | | | | | | | | |
| Standard Dev. | | | | | | | | | | | |
| (7) 8.66% | 53 | 51 | 52 | 53 | 52 | 0.077 | 73% | 1 | 3 | 4 | 2.7 |
| Glycerol + 2.25% | | | | | | | | | | | |
| NaCl | | | | | | | | | | | |
| Standard Dev. | | | | | 1.28 | 0.033 | | | | | |
| (8) 15.93% | 52 | 54 | 51 | ND | ND | >0.083 | 67% | | | | Excluded |
| Glycerol + 2.07% | | | | | | | | | | | |
| NaCl | | | | | | | | | | | |
| Standard Dev. | | | | | | | | | | | |
| (9) 22.57% | 52 | 54 | 51 | ND | ND | >0.106 | 90% | | | | Excluded |
| Glycerol | | | | | | | | | | | |
| Standard Dev. | | | | | | | | | | | |

The addition of both NaCl and/or glycerol in a specific concentration range appeared to be able to arrest the salt leakage from the reference frits. A concentration of 2.46% NaCl (Corresponds to 5-10% NaCl added to weight of KCl) appeared to be sufficient (Recipe 3), as did 8.85% glycerol (Corresponds to 10% glycerol added to weight of solution, excluding agar) (Recipe 2). The 2.46% NaCl (corresponding to 10% NaCl added by weight of KCl) by itself as an additive (Recipe 3) was the group that exhibited the lowest weight loss; however, this recipe also led to an increase in the number of dead frits on unsealing, and thus required manual activation of the frits with water.

The 8.85% glycerol (Corresponds to 10% glycerol added to weight of solution, excluding agar) by itself (Recipe 2) was second best for weight loss but was not optimal for Nernstian response or for active frits on un-taping.

The recipe which ranked best on all three parameters was recipe 5, which was a combination of 8.75% glycerol and 1.14% NaCl. It thus appears that the recipe that combines both the sodium chloride (NaCl) and the glycerol has the dual benefits of inhibiting salt leakage, while still maintaining active frits on un-taping. Adding too much glycerol (15.93% or more by weight of solution (Recipe 8)) had a negative impact as it led to higher rates of water loss. Previous experiments (experiment 1 above) suggest that NaCl concentrations less than 0.50% of the KCl concentration began to loose their anti-salt creep activity.

### Recipe Ranges

The experiments above suggest an optimum concentration of NaCl as 0.50%˜2.46% by weight of solution (corresponding to 2%-10% by weight added to the weight of KCl). The optimum concentration of glycerol was 4.6% to 12% of the weight of solution (corresponding to 5 to 15% glycerol added to weight of solution, excluding agar), but it would be expected that glycerol in the range of 4.6% to 15.93% by weight of solution (corresponding to 5-20% glycerol added to weight of solution, excluding agar) would also be operable and have beneficial attributes based on a reasonable extrapolation of current data.

The two additives acted together synergistically to inhibit salt creep and at the same time improve frit liquid junction wetting. Together, the addition of the secondary salt such as NaCl in the range of 0.6% to 2.46% range by weight of solution as well as an evaporation inhibiting agent such as glycerol in the range 4.6% to 15.93% (by weight of solution) would exhibit favourable characteristics. For more preferred characteristics, including inhibiting salt creep and improving the frit liquid junction welting, the addition of a secondary salt in the range of 0.6% to 2.25% by weight of solution together with glycerol in the range of 4.6% to 12% (by weight of solution) would be more preferred based on experiments 1 and 2. The gelling agent when used is typically added at around 2% by weight of solution, but the concentration of the gelling agent can vary over a wide range to produce the hardness required for the specific flow rate and mechanical properties most suitable to a particular reference electrode application.

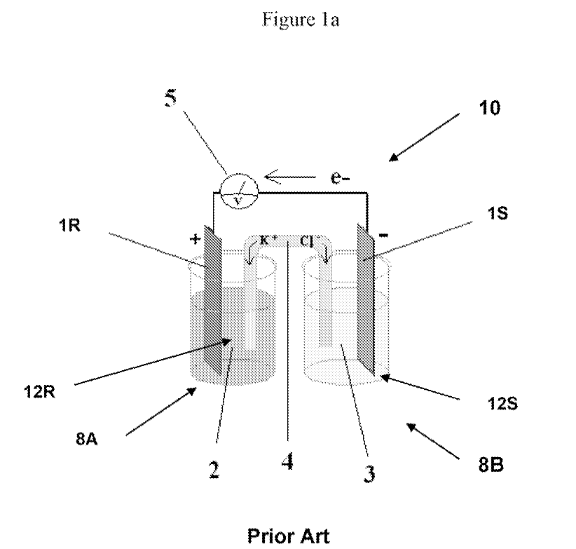

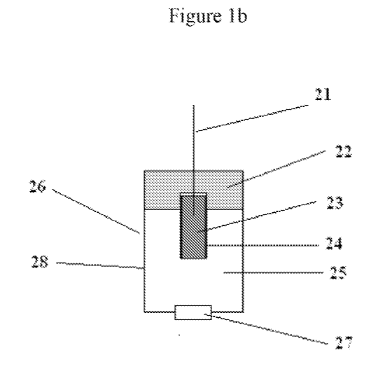

It is understood that the above noted recipe ranges are optimum for any KCl reference solution regardless of the type of electrode element. In particular, the above noted ranges for additives to a KCl reference solution would operate whether the electrode element is a silver/silver chloride element, such as illustrated on FIG. 1a by reference numeral 1R, or a mercury calomel electrode, as illustrated by reference numeral 23 in FIG. 1b, or any other type of electrode, as would be appreciated by a person skilled in the art.

Furthermore, it is understood that the above noted reference electrode could be used in a sensor or concentration cell to sense any type of ion, including pH. In particular, the reference electrode and reference solution described above can be used with virtually any ion selective electrode or pH electrode for a potentiometric measurement, where a conventional silver/silver chloride or mercury/calomel reference electrode would normally be used. This would include, but is not limited, to the following ions: H+, Li+, Na+, K+, NH4+, Ca2+, Mg2+, Cd2+, Cu2+, Ag+, Pb2+, S2−, CN—, Cl—, Br—, F—, I—, NO3—, OH—, ClO4−, pH.

In other words, it is understood that while the preferred embodiment was described above with reference to a device 200, as illustrated in FIG. 2 to measure Cl— but, the present invention is not restricted to sensing Cl—, but rather can be used with any type of ion selective electrode or pH electrode.

To the extent that a patentee may act as its own lexicographer under applicable law, it is hereby further directed that ail words appearing in the claims section, except for the above defined words, shall take on their ordinary, plain and accustomed meanings (as generally evidenced, inter alia, by dictionaries and/or technical lexicons), and shall not be considered to be specially defined in this specification. Notwithstanding this limitation on the inference of “special definitions,” the specification may be used to evidence the appropriate ordinary, plain and accustomed meanings (as generally evidenced, inter alia, by dictionaries and/or technical lexicons), in the situation where a word or term used in the claims has more than one pre-established meaning and the specification is helpful in choosing between the alternatives.”

It will be understood that, although various features of the invention have been described with respect to one or another of the embodiments of the invention, the various features and embodiments of the invention may be combined or used in conjunction with other features and embodiments of the invention as described and illustrated herein.

Although this disclosure has described and illustrated certain preferred embodiments of the invention, it is to be understood that the invention is not restricted to these particular embodiments. Rather, the invention includes all embodiments, which are functional, electrical or mechanical equivalents of the specific embodiments and features that have been described and illustrated herein.

What is claimed:

1. An electrolyte reference solution for use in a reference electrode, said solution being in electrochemical contact with an electrode member of the reference electrode, said solution comprising:
(a) a 1M to saturated aqueous KCl solution;
(b) 0.6% to 2.46% (by weight of solution) of a secondary water-soluble inorganic chloride salt other than KCl; and
(c) 4.6% to 15.93% (by weight of solution) of an evaporation inhibiting agent.

2. The reference solution as defined in claim 1, wherein said secondary chloride salt is selected from the group consisting of MgCl₂, CaCl₂, LiCl, CuCl₂, BaCl₂ and NaCl.

3. The reference solution as defined in claim 1, wherein the secondary chloride salt is NaCl.

4. The reference solution as defined in claim 1, wherein the evaporation inhibiting agent is selected from the group consisting of polyhydric alcohols.

5. The reference solution as defined in claim 1 wherein the evaporation inhibiting agent is selected from the group consisting of diols, triols and higher polyols.

6. The reference solution as defined in claim 1 wherein the evaporation inhibiting agent is from the group consisting of polyethylene glycol, monosaccharides, disaccharides, or sorbitol.

7. The reference solution as defined in claim 5 wherein the evaporation inhibiting agent is glycerol.

8. The reference solution as defined in claim 1, further comprising a gelling agent to form a gelled reference solution.

9. The reference solution as defined in claim 8, wherein the gelling agent is selected from the group consisting of gelatin and water-soluble polysaccharides including starch, agar, amylose, dextranes, carboxymethyl cellulose sodium salt and mixtures thereof.

10. The reference solution as defined in claim 1, wherein the solution comprises 0.6% to 2.25% (by weight of solution) of a secondary water-soluble inorganic chloride salt other then KCl, and, 4.6% to 12% (by weight of solution) of an evaporation inhibiting agent.

11. The reference solution as defined in claim 8, wherein the gelling agent is selected from the group consisting of polyacrylic and polymethacrylic acids and their water soluble derivatives such as their sodium and potassium salts, polyacrylamide, polyhydroxyethylacrylate, polyhydroxyethylmethacrylate, and polyvinyl alcohol and mixtures of thereof.

12. The reference solution as defined in claim 1 wherein the aqueous KCl solution is saturated with KCl.

13. The reference solution as defined in claim 1 wherein the electrode member is selected from the group consisting of a silver/silver chloride electrode member and a mercury/mercury I chloride mixture.

14. The reference solution as defined in claim 1 further comprising a gelling agent; and wherein the electrode member is silver/silver chloride, the concentrated KCl solution is saturated, the secondary salt is NaCl and the evaporation inhibiting agent is glycerol.

15. A half-cell reference electrode comprising:
an electrode member comprising silver/silver chloride;
a gelled or viscous reference solution in electrochemical contact with the electrode member, said reference solution comprising a 1M to saturated potassium chloride solution (KCl) and 4.6% to 15.93% (by weight of solution) of an evaporation inhibiting agent;
a porous liquid junction portion for facilitating electrochemical contact between the reference solution and a test solution.

16. A half-cell reference electrode comprising:
an electrode member comprising silver/silver chloride;
a gelled or viscous reference solution in electrochemical contact with the electrode member, said reference solution comprising a 1M to saturated potassium chloride solution (KCl) and 0.5% to 2.46% (by weight of solution) of a secondary water soluble inorganic chloride salt other than KCl; and
a porous liquid junction portion for facilitating electrochemical contact between the reference solution and a test solution.

17. The electrode as defined in claim 16, wherein the reference solution further comprises up to about 18% by weight of solution of an evaporation inhibiting agent.

18. The electrode as defined in claim 16 wherein the reference solution comprises 4.6% to about 12% by weight of an evaporation inhibiting agent selected from the group consisting of diols, triols and higher polyols; and wherein the secondary salt comprises 0.6% to 2.46% (by weight of solution) and is selected from the group consisting of NaCl, MgCl₂ and CaCl₂.

19. The electrode as defined in claim 18 wherein the gelled reference solution is formed by adding a gelling agent selected from the group consisting of starch, agar, amylose, dextranes, carboxymethyl cellulose sodium salt and mixtures thereof.

20. The electrode as defined in claim 19 wherein the gelling agent is agar, the secondary salt is NaCl and the evaporation Inhibiting agent is glycerol.
